(19) United States
(12) Patent Application Publication
(10) Pub. No.: US 2014/0138365 A1
(43) Pub. Date: May 22, 2014

(54) WELDING APPARATUS

(71) Applicant: HON HAI PRECISION INDUSTRY CO., LTD., New Taipei (TW)

(72) Inventors: CHENG-HSIU YANG, New Taipei (TW); CHENG-HSIU WU, New Taipei (TW)

(73) Assignee: HON HAI PRECISION INDUSTRY CO., LTD., New Taipei (TW)

(21) Appl. No.: 13/707,604

(22) Filed: Dec. 7, 2012

(30) Foreign Application Priority Data
Nov. 19, 2012 (TW) 101143062

(51) Int. Cl. B23K 9/00

(52) U.S. Cl. CPC B23K 9/00
USPC 219/136

(57) ABSTRACT

A welding apparatus to weld two wires includes a chassis, a direct current (DC) power supply, and a contacting plate. The contacting plate is electrically connected to a cathode of the DC power supply. The chassis defines an entrance aligned with the contacting plate. A socket is attached to the chassis and electrically connected to the anode of the DC power supply. Separated ends of the wires are connected to the socket. Joint ends of the metal wires are twisted together and extend into the chassis through the entrance to contact with the contacting plate to cause a rush current to flow through the wires.

### BACKGROUND

1. Technical Field

The present disclosure relates to a welding apparatus.

2. Description of Related Art

A thermocouple structure for high temperature applications usually includes a pair of thermocouple wires joined at corresponding ends. Traditionally, the corresponding ends of the wires are joined with manual soldering. However, manual soldering has to conducted by a skillful operator, which is inconvenient.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an isometric, exploded view of an exemplary embodiment of a welding apparatus, and a first wire and a second wire.

FIG. 2 shows the welding apparatus of FIG. 1 in use.

FIG. 3 schematically shows the welding apparatus of FIG. 1.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

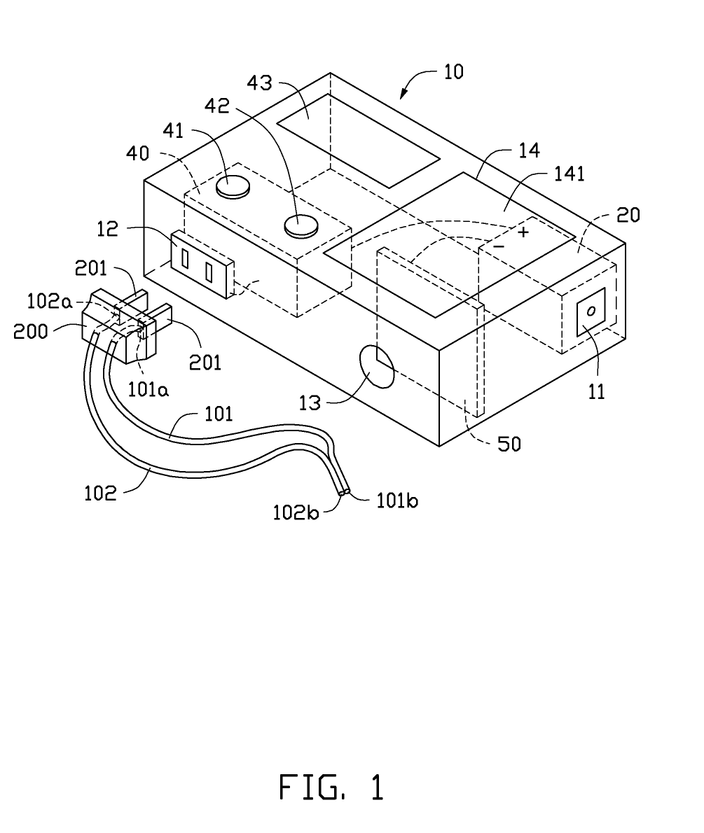

FIG. 1 shows an exemplary embodiment of a welding apparatus. The welding apparatus is used to weld a joint end 101b of a first wire 101 and a joint end 102b of a second wire 102 together. In one embodiment, the first and second wires 101 and 102 are couple wires of thermocouple structure. A separated end 101a of the first wire 101 and a separated end 102a of the second wire 102 extend into a plug 200 and are respectively connected to two connecting pins 201 of the plug 200. The welding apparatus includes a chassis 10, and a direct current (DC) power supply 20, a voltage regulator 40, and a contacting plate 50 all arranged in the chassis 10.

The chassis 10 is a rectangular box. The DC power supply 20 includes an input connector 11 exposed through a right side of the chassis 10. A socket 12 is mounted to a front side of the chassis 10. The front side of the chassis 10 defines an entrance 13 aligned with the contacting plate 50. The voltage regulator 40 includes two buttons 41 and 42, and a display 43 all exposed through a top of the chassis 10. The buttons 41 and 42 are operable to respectively decrease or increase the voltage between the contacting plate 50 and the sockets 12. The top of the chassis 10 further defines an observation window 14 aligned with the contacting plate 50. An anti-dazzling screen 141 is embedded in the observation window 14.

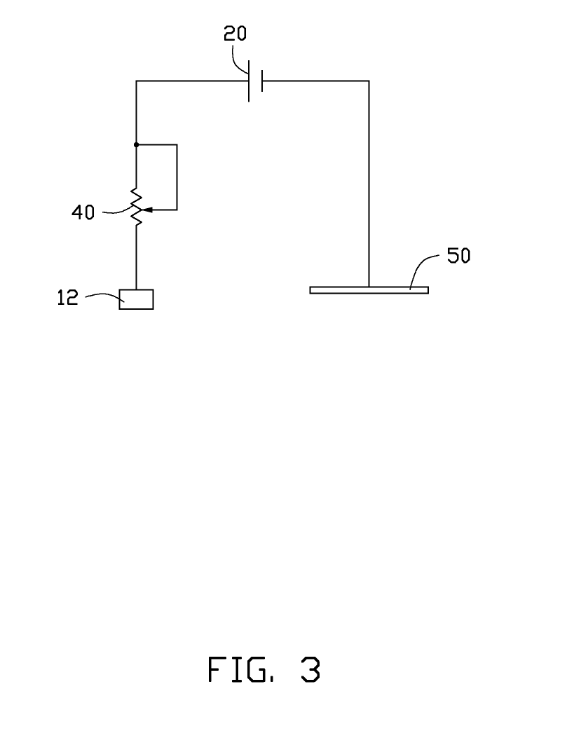

FIG. 3 shows that the contacting plate 50 is electrically connected to a cathode of the DC power supply 20. The voltage regulator 40 is electrically connected between the socket 12 and an anode of the DC power supply 20, for adjusting a voltage between the contacting plate 50 and the socket 12. In one embodiment, the voltage regulator 40 is a variable resistor. The buttons 41 and 42 are operable to respectively decrease or increase the resistance of the variable resistor.

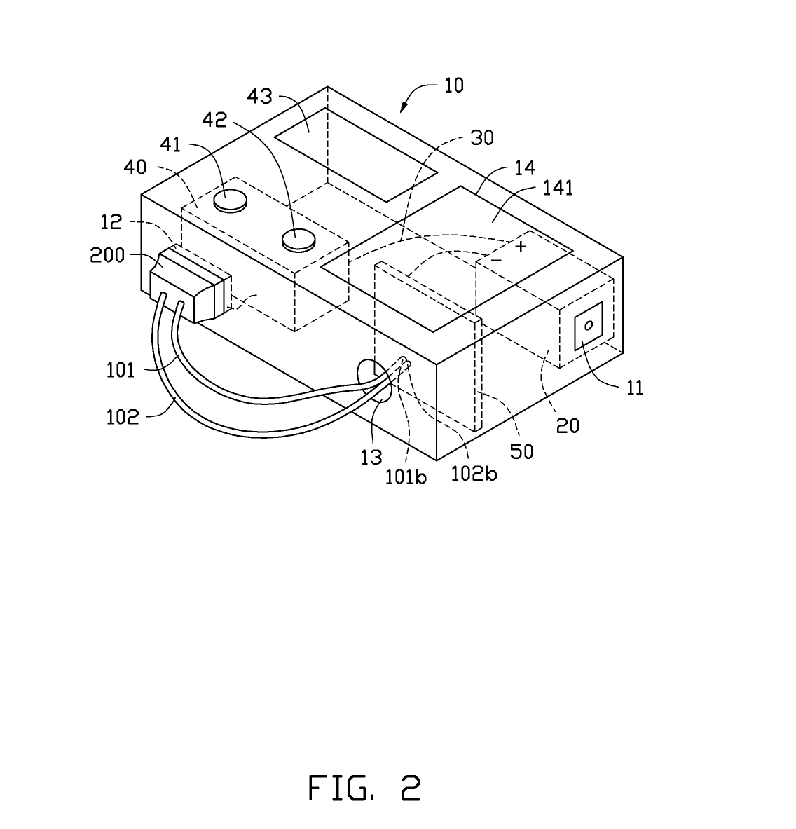

FIG. 2 shows that in use, the connecting pins 201 of the plug 200 are engaged in the socket 12 to make the separated ends 101a and 102a of the first and second wires 101 and 102 be electrically connected to the anode of the power supply 20. The joint ends 101b and 102b are twisted together. The power supply 20 is connected to a commercial alternating current power through the input connector 11, and outputs a DC power between the anode and the cathode of the power supply 20. The first and second wires 101 and 102 are handled to make the joint ends 101b and 102b enter the chassis 10 through the entrance 13 and contact with the contacting plate 50. At the moment of the joint ends 101b and 102 contacting with the contacting plate 50, a rush circuit flows through the first and second wires 101 and 102. However, since there are contacting impedance between the joint ends 101b and 102b, and the contacting plate 50, a mass of heat is generated at the joint ends 101b and 102b to melt the joint ends 101b and 102b and weld the joint ends 101b and 102b together. In operation, operators can obverse the first and second wires 101 and 102 through the window 14. The anti-dazzling screen 41 protects the operators from being hurt by sparks of welding. Since the thermal capacity of the contacting plate 50 is far greater than the thermal capacity of the first and second wires 101 and 102, the contacting plate 50 will not be melted in the welding process.

It is to be understood, however, that even though numerous characteristics and advantages of the embodiment have been set forth in the foregoing description, together with details of the structure and function of the embodiment, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A welding apparatus for welding two wires together, each of the wires comprising a joint end and a separated end opposite to the joint end, the welding apparatus comprising:
a chassis defining an entrance through which the joint ends of the wires extend into the chassis;
a direct current (DC) power supply accommodated in the chassis;
a socket mounted to the chassis and electrically connected to an anode of the DC power supply to enable the separated ends of the two wires to electrically connect with the anode of the DC power supply; and
a contacting plate accommodated in the chassis, aligned with the entrance of the chassis, and electrically connected to a cathode of the DC power supply, to contact with the joint ends of the two wires, thereby cause a rush current flowing through the two wires.

2. The welding apparatus of claim 1, wherein the chassis further defines an observing window aligned with the contacting plate, an anti-dazzling screen is embedded in the observing window.

3. The welding apparatus of claim 1, further comprising a voltage regulator electrically connected between the socket and the anode of the DC power supply, for adjusting a voltage between the contacting plate and the socket.

4. The welding apparatus of claim 3, wherein the voltage regulator comprises two buttons exposed through a top of the chassis, respectively operable to increase or decrease the voltage between the contacting plate and the socket.

5. The welding apparatus of claim 4, wherein the voltage regulator is a variable resistor, the buttons are operable to respectively decrease or increase the resistance of the variable resistor.

6. The welding apparatus of claim 1, wherein the DC power supply comprises an input connector exposed through a side of the chassis.
